(19) United States
(12) Patent Application Publication
(10) Pub. No.: US 2007/0231681 A1
(43) Pub. Date: Oct. 4, 2007

(54) IMMOBILIZATION SYSTEM FOR AN ELECTROCHEMICAL CELL

(76) Inventors: Kurt J. Casby, Grant, MN (US); Anthony W. Rorvick, Champlin, MN (US); Christian S. Nielsen, River Falls, WI (US); Timothy T. Bomstad, Inver Grove Heights, MN (US); David P. Haas, Brooklyn Park, MN (US); Angela Rodgers, Minneapolis, MN (US)

Correspondence Address: MEDTRONIC, INC., 710 MEDTRONIC PARKWAY NE, MINNEAPOLIS, MN, 55432-9924, US

(21) Appl. No.: 11/278,217

(22) Filed: Mar. 31, 2006

(51) Int. Cl. H01M 2/18; H01M 2/08

(52) U.S. Cl. 429/129; 429/208; 429/185

(57) ABSTRACT

An electrochemical cell of an implantable medical device is provided. The electrochemical cell comprises a conductive case and a cover welded to the case to form a hermetically-sealed housing. A cathode is disposed adjacent to a surface of the case within the hermetically-sealed housing and an anode is disposed within the hermetically-sealed housing. An immobilization system is disposed between the anode and the hermetically-sealed housing. The immobilization system is configured to minimize movement of the anode relative to the housing and is adapted to thermally insulate the anode during fabrication of the hermetically-sealed housing.

### FIELD OF THE INVENTION

The present invention generally relates to electrochemical cells, and more particularly relates to immobilization systems of electrochemical cells of implantable medical devices.

### BACKGROUND OF THE INVENTION

Implantable medical devices (IMDs) are well known for providing a variety of treatments to humans and animals. For example, implantable cardiac defibrillators are used to monitor the electrical activity of the heart of a patient, detect ventricular fibrillation, and in response to that detection, deliver appropriate shocks to restore a normal heart rhythm. Implantable neurostimulators have been used to stimulate the spinal cord and brain for a variety of treatments, including the treatment of chronic pain and the treatment of peripheral vascular disease. Implantable pacemakers generate and apply electric stimuli in the form of pulses to the tissue of a heart to control the timing of the contractions of the heart.

The above-described IMDs, and other similar devices, utilize an internal power source, or electrochemical cell, such as a battery and/or a capacitor, to provide the power required for a desired application. Depending upon the particular application, the power source may be required to provide energy of as little as 0.1 Joules or less, such as for pacemakers, to as much as 40 Joules or greater, as in the case of implantable defibrillators. In addition to providing sufficient energy, the power source preferably possesses low self-discharge to have a useful life and should be highly reliable.

A class of electrochemical cells used in IMDs comprises a conductive housing that is formed of a metal case and a metal cover welded thereto. At least one cathode is disposed adjacent to an internal surface of the housing and an anode is disposed within the housing. A liquid electrolyte also is disposed within the housing to operatively associate the anode and the cathode. Such electrochemical cells have certain design challenges. While separator means usually are provided to keep the anode from contacting the cathode, the anode typically is not anchored to the housing and is free to move within the housing. Such movement may damage the anode, the cathode, and other elements of the electrochemical cell. In addition, if the anode contacts the metal housing, a short circuit may result. Furthermore, the housing of this class of electrochemical cells typically is fabricated by welding the metal case to the metal cover, thereby forming a hermetic seal. However, heat produced by the welding may damage components within the housing, particularly the anode and the separator means.

Accordingly, it is desirable to provide an immobilization system within the electrochemical cell housing that minimizes movement of the anode relative to the housing. In addition, it is desirable to provide an immobilization system that insulates the anode from thermal energy generated during fabrication of the housing. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

An electrochemical cell of an implantable medical device in accordance with an exemplary embodiment of the present invention is provided. The electrochemical cell comprises a conductive case and a cover welded to the case to form a hermetically-sealed housing. A cathode is disposed adjacent to a surface of the case within the hermetically-sealed housing and an anode is disposed within the hermetically-sealed housing. An immobilization system is disposed between the anode and the hermetically-sealed housing. The immobilization system is configured to minimize movement of the anode relative to the housing and is adapted to thermally insulate the anode during fabrication of the hermetically-sealed housing.

An electrochemical cell of an implantable medical device in accordance with another exemplary embodiment of the present invention is provided. The electrochemical cell comprises a hermetically-sealed housing formed by welding and an anode disposed within the hermetically-sealed housing. An immobilization system is disposed between the anode and the housing. The immobilization system is configured to substantially restrict movement of the anode relative to the housing and is formed of a non-electrically conductive material that thermally insulates the anode during the welding.

An immobilization system of an electrochemical cell of an implantable medical device in accordance with an exemplary embodiment of the present invention is provided. The electrochemical cell has a hermetically-sealed housing formed by welding and an anode is disposed within the housing. The immobilization system comprises a first surface adapted for physical contact with an interior surface of the hermitically-sealed housing and a second surface adapted for physical contact with an exterior surface of the anode. The immobilization system also has an intermediate portion disposed between the first surface and the second surface. The intermediate portion has a thickness such that the immobilization system is adapted to substantially restrict movement of the anode relative to the housing and comprises a material that thermally insulates the anode during the welding of the hermitically-sealed housing.

### BRIEF DESCRIPTION OF THE DRAWINGS

The present invention will hereinafter be described in conjunction with the following drawing figures, wherein like numerals denote like elements, and wherein:

FIG. 1 is a perspective, exploded view of an electrochemical cell in accordance with an exemplary embodiment of the present invention;

FIG. 2 is a cross-sectional view of the electrochemical cell of FIG. 1;

FIG. 3 is a cross-sectional view of an electrochemical cell in accordance with another exemplary embodiment of the present invention;

FIG. 4 is a perspective view of an immobilization system in accordance with an exemplary embodiment of the present invention;

FIG. 5 is a perspective view of an immobilization system in accordance with another exemplary embodiment of the present invention;

FIG. 6 is a perspective cross-sectional view of an immobilization system in accordance with another exemplary embodiment of the present invention;

FIG. 7 is a perspective, exploded view of an immobilization system in accordance with a further exemplary embodiment of the present invention;

FIG. 8 is a cross-sectional view of an electrochemical cell in accordance with an exemplary embodiment of the present invention;

FIG. 9 is a cross-sectional view of an electrochemical cell in accordance with another exemplary embodiment of the present invention;

FIG. 10 is a cross-sectional view of an electrochemical cell in accordance with a further exemplary embodiment of the present invention; and

FIG. 11 s a cross-sectional view of an electrochemical cell in accordance with a further exemplary embodiment of the present invention.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

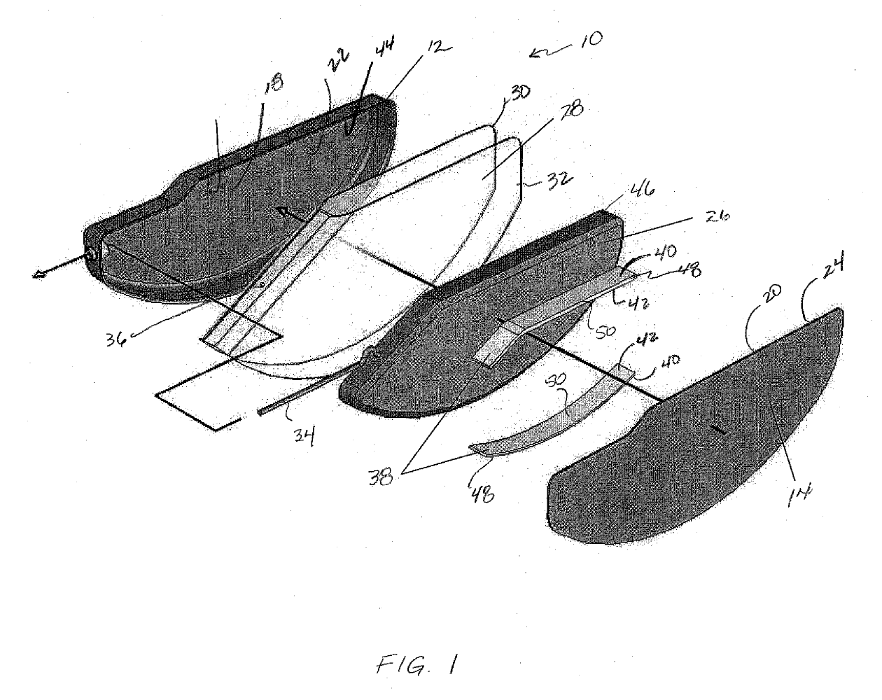

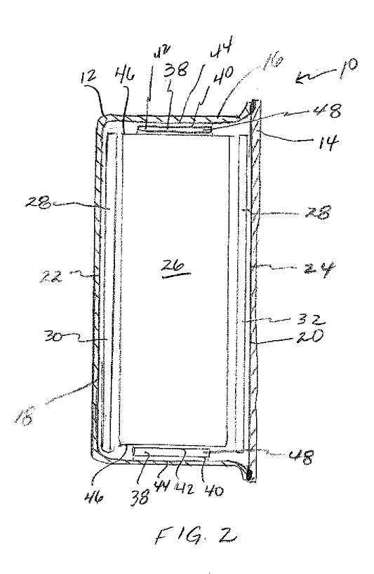

An exploded view of an electrochemical cell 10 in accordance with an exemplary embodiment of the present invention is illustrated in FIG. 1. While electrochemical cell 10 may be a capacitor, a battery, or the like, for illustrative purposes, the electrochemical cell of the various embodiments of the present invention will be described with reference to a capacitor. Electrochemical cell 10 may be designed with any suitable shape to conform to a housing of an implantable medical device within which electrochemical cell 10 will be installed. For illustrative purposes, capacitor 10 has a substantially semicircle shape. Electrochemical cell 10 comprises a case 12 and a cover 14, both formed of a conductive material, preferably a metal such as tantalum, titanium, nickel, molybdenum, niobium, cobalt, stainless steel, tungsten, platinum, palladium, gold, silver, copper, chromium, vanadium, aluminum, zirconium, hafnium, zinc, iron, or mixtures or alloys thereof. As illustrated in FIG. 2, case 12 and cover 14 are joined together, preferably by welding, more preferably by laser welding, to form a hermetically-sealed housing 16, which forms a first terminal of the electrochemical cell 10. While case 12 is illustrated in FIG. 2 having a lip that contacts a surface of case 14, it will be appreciated that case 12 and cover 14 can contact each other in any suitable manner, such as, for example, in a “box and lid” configuration.

Referring to FIGS. 1 and 2, a cathode active material is disposed on an interior surface 18 of case 12 and on an interior surface 20 of cover 14 to form a first cathode 22 and a second cathode 24, respectively. The cathode active material may comprise any suitable cathodic material and is either directly coated on the interior surfaces 18 and 20 or is coated on a conductive substrate (not shown) in electrical contact with the interior surfaces.

An anode 26 is disposed within hermetically sealed housing 16 between first cathode 22 and second cathode 24 and is formed of a solid sintered metal powder, as is well known in the industry. Anode 26 has a shape that generally mimics the interior shape of hermetically sealed housing 16 and is undersized relative to the interior of hermetically sealed housing 16 so that it may be disposed therein and so that it does not contact the housing 16. The first and second cathodes 22 and 24 are operatively associated with the anode by a working electrolyte (not shown) contained inside hermetically sealed housing 16. An anode pin 34 extends from the anode 26 through the case 12 forming a second terminal of the electrochemical cell 10.

A separator 28 is disposed between the anode 26 and first and second cathodes 22 and 24 and may have any suitable shape that at least substantially separates the anode from the cathode. In one exemplary embodiment, separator 28 may comprises a first element 30 disposed between first cathode 22 and anode 26 and a second element 32 disposed between second cathode 24 and anode 26. First and second element 30 and 32 may be joined together to completely envelope anode 26 (not shown) or only a portion of first element 30 and a portion of second element 32 may be joined together. In either case, separator 28 may also have an orifice 36 that permits anode pin 34 to extend through the separator. In an alternative embodiment of the invention, first element 30 and second element 32 are not joined together. Separator 28 may be comprised of a suitable electrically insulative material to prevent an internal electrical short circuit between the anode 26 and cathodes 22, 24. Separator 28 is suitably porous to allow flow of the electrolyte therethrough during the electrochemical reaction of the electrochemical cell 10. Suitable materials for separator 28 include, but are not limited to, polyethylene, polypropylene, and polytetrafluoroethylene.

Electrochemical cell 10 further comprises at least one immobilization system 38 that substantially restricts the motion of anode 26 relative to hermetically sealed housing 16, thus minimizing damage to the anode caused by impact with the interior surface of the housing 16. In addition, the immobilization system 38 thermally insulates anode 26 during welding of the cover 14 and the case 12. The immobilization system 38 may thermally insulate anode 26 by positioning the anode a sufficient distance from where the welding takes place between the case 12 and the cover 14 so that heat is prevented from damaging the anode and surrounding separator material. Alternatively, or in addition, the immobilization system 38 may insulate anode 26 by acting as a heat sink or otherwise preventing conduction of heat from the weld to the anode.

Immobilization system 38 comprises any suitable electrically insulative material, such as a polymer, glass, or ceramic, that is resistant to corrosion by the electrolyte. Preferably, immobilization system 38 comprises a polymer having thermal insulating properties, such as, for example, polypropylene, polytetrafluoroethylene, ethylene tretrafluoroethylene, silicones, polyolefins, polyimides, polyetherimides, liquid crystal polymers, and the like. In accordance with another exemplary embodiment of the present, immobilization system 38 may comprise a polymeric material that undergoes a phase transition when heated. Such polymeric materials include polymers having a high degree of crystallinity, such as, for example, high density polyethylene. In accordance with a further exemplary embodiment of the present invention, immobilization system 38 may comprise a laminate or other combination of the above-described materials. For example, immobilization system 38 may comprise a highly thermally conductive laminate of polymers and metals that limit movement of the anode 26 within the housing 16 and that conduct heat away from anode 26. Immobilization system 38 may be formed by any suitable method, such as, for example, molding, extrusion, stamping, cutting to size, and the like.

Immobilization system 38 comprises a first surface 40 that is adapted for contact with an interior surface 44 of hermetically sealed housing 16 and a second surface 42 that is adapted for contact with an exterior surface 46 of anode 26, or an exterior surface 46 of separator 28, as the case may be. As used herein, the term “exterior surface 46” of anode 26 comprises an exterior surface of the anode itself or an exterior surface of any material that is disposed between the second surface 42 of immobilization system 38 and anode 26. Immobilization system 38 has an intermediate portion 48 between first surface 40 and second surface 42. Intermediate portion 48 has any suitable thickness between surfaces 40 and 42 such that immobilization system 38 limits movement of the anode 26 relative to hermetically sealed housing 16. In one exemplary embodiment of the present invention, the thickness of the intermediate portion 48 is such that, when immobilization system 38 is disposed between anode 26 and housing 16, first surface 40 substantially contacts interior surface 44 and second surface 42 substantially contacts exterior surface 46. In another embodiment of the present invention, immobilization system 38 is slightly undersized in thickness so that, when disposed between anode 26 and housing 16, first surface 40 does not necessarily contact interior surface 44 at the same time that second surface 42 contacts exterior surface 46.

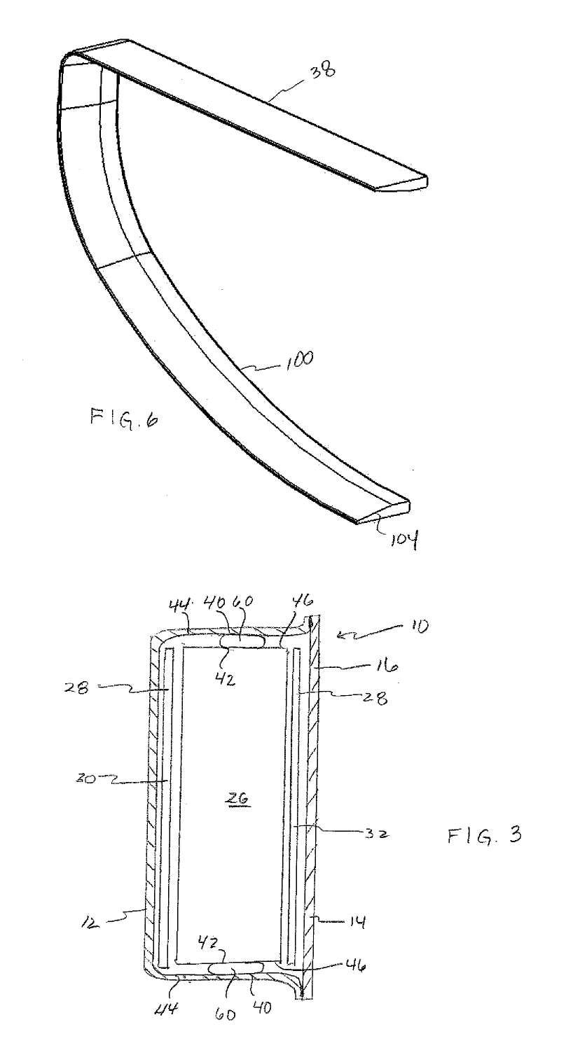

The immobilization system 38 may take on any suitable shape or form. In one exemplary embodiment of the invention, as illustrated in FIG. 1, the immobilization system 38 may comprise a plurality of immobilization strips 50 having a square or rectangular cross section. Immobilization strips 50 are disposed between hermetically sealed housing 16 and anode 26 and extend over a portion of exterior surface 46. While two immobilization strips 50 are illustrated in FIG. 1, it will be appreciated that any suitable number of strips may be utilized. In another exemplary embodiment of the invention, the immobilization system 38 may comprise a plurality of immobilization tubes or cords 60 having a circular or elliptical cross section, as illustrated in FIG. 3. In a further exemplary embodiment of the invention, the immobilization system 38 may comprise a plurality of immobilization wedges or shims (not shown).

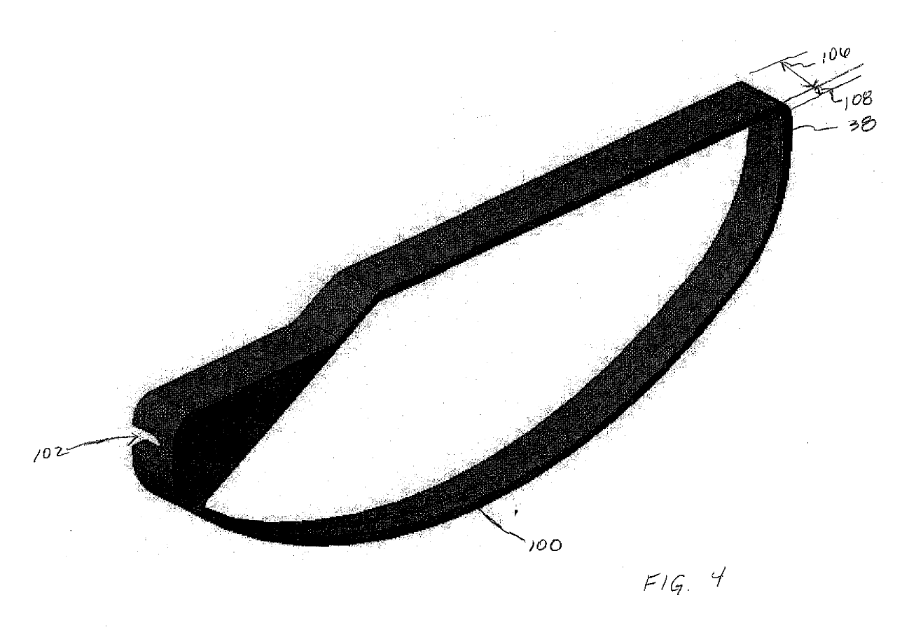

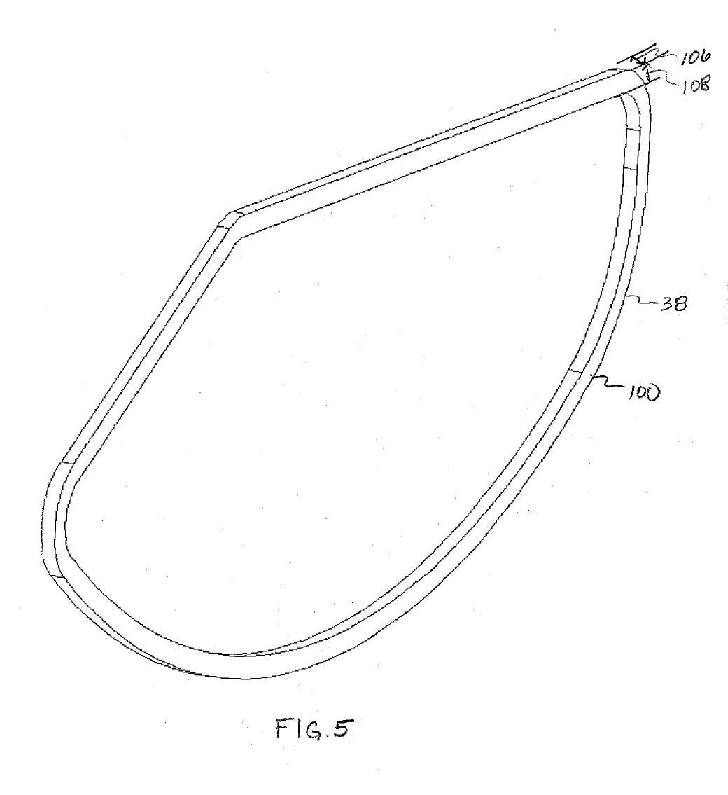

Referring to FIG. 4, in accordance with another exemplary embodiment of the present invention, immobilization system 38 may comprise an immobilization ring 100. Immobilization ring 100 is configured to extend or wrap around an exterior surface 46 of anode 26 (not shown in FIG. 4). Immobilization ring 100 may comprise any of the materials described above for immobilization system 38 and may have a relatively stiff form in the shape of anode 26 or may have a relatively flexible form that can be formed about anode 26, such as a rubber band may be formed about the anode. Immobilization ring 100 further may comprise an orifice or opening 102 through which anode pin 34 may extend. Further, immobilization ring 100 may have any suitable shape and dimensions. For example, as illustrated in FIG. 4, immobilization ring 100 may have a relatively wide thickness, represented by double-headed arrow 106, and a relatively thin height, represented by double-headed arrow 108. In another example, as illustrated in FIG. 5, immobilization ring 100 may have a relatively narrow thickness 106 and a relatively high height 108. In another exemplary embodiment of the invention, as illustrated in FIG. 6, immobilization ring 100 may comprise a beveled or chamfered edge 104 along one or both edges of ring 100. In this manner, the anode 26 may be inserted within ring 100 with guidance from the chamfered edge.

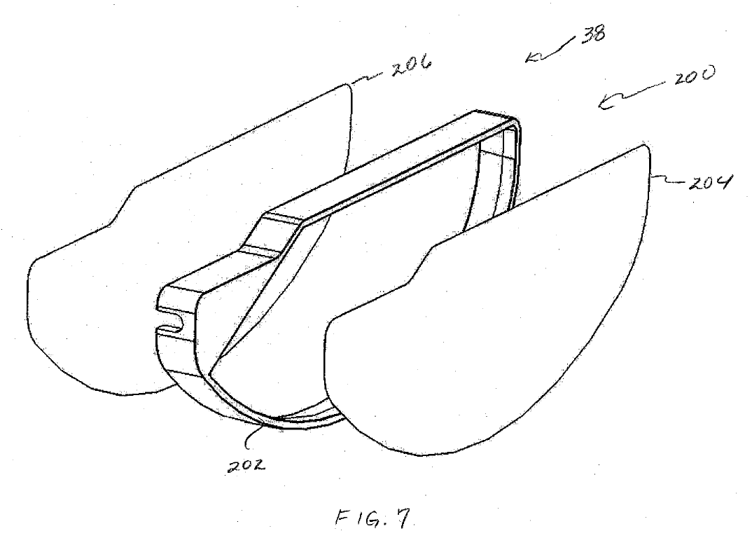

In accordance with a further exemplary embodiment of the present invention, as illustrated in FIG. 7, immobilization system 38 may have the shape of a drum 200 that can envelope anode 26. Drum 200 comprises a band 202 physically joined to a first side surface 204 and a second side surface 206. Again, drum 200 may comprise any of the materials described above for immobilization system 38. During assembly, in one exemplary embodiment, band 202 may be disposed on first side surface 204 and anode 26 may be disposed within band 202. Second side surface 206 may then be disposed on band 202 and first and second side surfaces 204, 206 may be bonded to band 202 by thermal energy, sonic energy, adhesive, or the like. Alternatively, first side surface 204 may be bonded to band 202 to form a cup within which anode 26 is disposed. Second side surface 204 then may be bonded to band 202 to envelope anode 26. Of course, it will be appreciated that drum 200 may be formed about anode 26 by any other suitable method. First side surface 204 and second side surface 206 may be formed of the same material(s) as band 202, although it will be appreciated that first and second side surfaces 204, 206 will be sufficiently porous to permit the electrolyte to flow between anode 26 and the cathodes 22, 24. Alternatively, first side surface 204 and second side surface 206 may be formed of a material different from band 202. For example, first and second side surfaces 204, 206 may comprise separator 28, particularly first element 30 and second element 32 of separator 28.

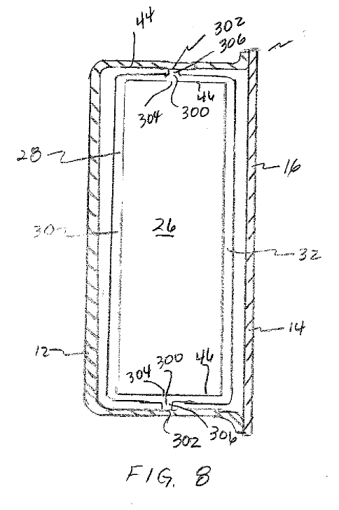

In accordance with another exemplary embodiment of the present invention, immobilization system 38 may comprise bumpers 300 formed of seals of first element 30 and second element 32 of separator 28, as illustrated in FIG. 8. Portions of first element 30 and second element 32 may be sealed together about the entirety of anode 26 to envelope anode 26 or partially about anode 26. Elements 30 and 32 may be sealed together using any suitable method, such as by adhesive, thermal energy, sonic energy, and the like. The seals form bumpers that extend from anode 26 into the space between the anode/separator and housing 16. The bumpers 300 restrict movement of anode 26 relative to housing 16. The bumpers 300 comprise a first surface 302 that is adapted for contact with the interior surface 44 of housing 16, a second surface 304 that is adapted for contact with the exterior surface 46 of anode 26, and an intermediate portion 306 between surfaces 302 and 304.

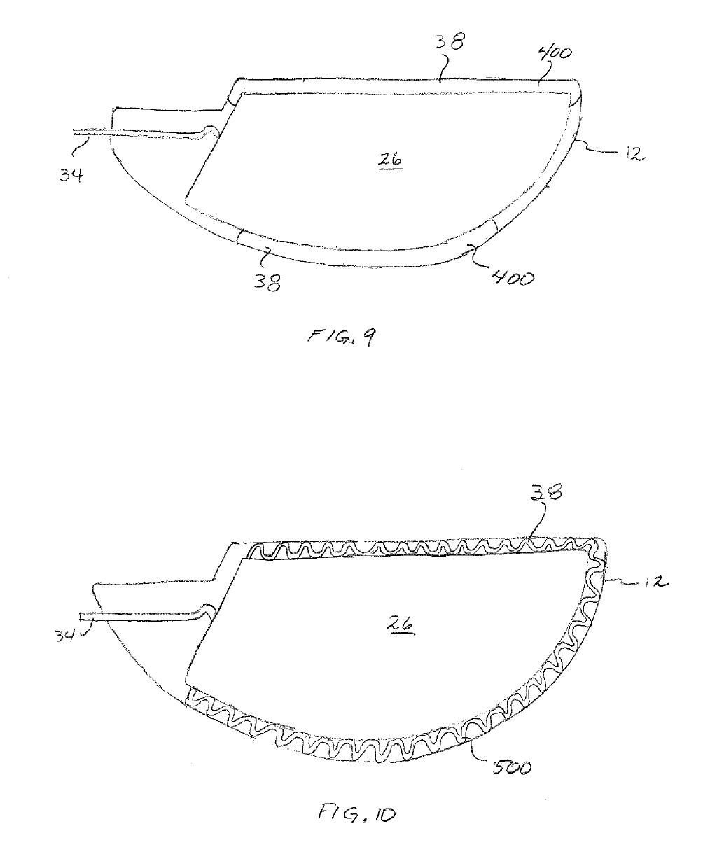

Referring to FIG. 9, in accordance with another exemplary embodiment of the invention, immobilization system 38 may comprise one or more bumpers 400 made of polymer foam or spray. The foam or spray bumpers may be pre-made and inserted in the space between the housing 16 and the anode 26 or, preferably, are injected or sprayed as a viscous liquid into the space between the housing 16 and the anode 26 and permitted to cure. Once cured, the foam or spray bumpers restrict movement of the anode relative to the housing 16. In addition, the foam or spray bumpers may thermally insulate the anode 26 during welding of housing 16. In another exemplary embodiment of the invention, the bumpers may be made of an epoxy that is injected into the space between the housing 16 and the anode 26. In this manner, the anode 26 may be rigidly anchored to the housing to prevent movement.

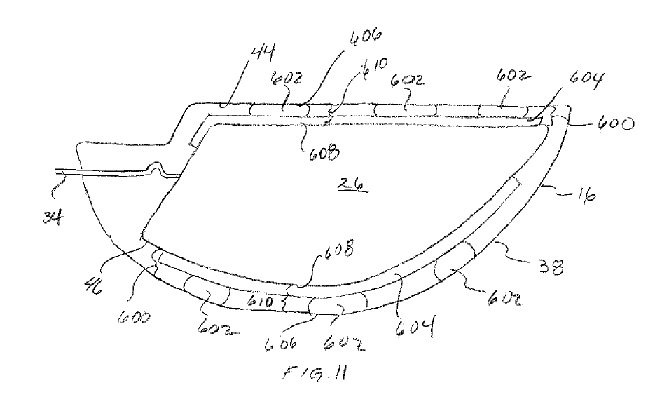

In accordance with another exemplary embodiment of the invention, immobilization system 38 may comprise a thin film 500 that has been corrugated or otherwise gathered or crumbled in the space between the housing 16 and the anode 26 to absorb impact between the anode and the housing, as illustrated in FIG. 10. The corrugated thin film 500 may comprise any of the polymer materials described above for immobilization system 38 and may be formed of a polymer material that prevents conduction of heat to the anode during welding of the housing 16.

Immobilization system 38 also may comprise any combination of the foregoing configurations. For example, in FIG. 11, immobilization system 38 may comprise a combination 600 of one or more immobilization strips 604 and one or more epoxy or polymer foam or spray bumpers 602. The immobilization strips 604 may thermally insulate anode 26 during welding and the bumpers 602 and strips 604 restrict motion of the anode relative to the hermetically sealed housing. As described above regarding the previously presented immobilization systems, combination 600 comprises a first surface 606 that is adapted for contact with the interior surface 44 of housing 16, a second surface 608 that is adapted for contact with the exterior surface 46 of anode 26, and an intermediate portion 610 comprising the strips and the bumpers. Intermediate portion 610 has any suitable thickness between surfaces 606 and 608 such that combination 600 limits movement of the anode 26 relative to hermetically-sealed housing 16. In one exemplary embodiment of the present invention, the thickness of the intermediate portion 610 is such that, when disposed between anode 26 and housing 16, first surface 606 contacts interior surface 44 and second surface 608 contacts exterior surface 46. In another embodiment of the present invention, combination 600 is slightly undersized in thickness so that, when disposed between anode 26 and housing 16, first surface 606 does not necessarily contact interior surface 44 at the same time that second surface 508 contacts exterior surface 46. While immobilization strips and bumpers are illustrated as a combination 600 forming immobilization system 38, immobilization system 38 may comprise any other suitable combination of immobilization elements, such as, for example, a combination of an immobilization ring and bumpers, an immobilization ring and a thin corrugated member, and the like.

Accordingly, an immobilization system for an electrochemical cell is disclosed. The immobilization system restricts movement of an internal anode with respect to an external hermetically sealed housing and thermally insulates the anode during fabrication of the housing. While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

1. An electrochemical cell of an implantable medical device, the electrochemical cell comprising:
a conductive case;
a cover welded to the case to form a hermetically-sealed housing;
a cathode disposed adjacent to a surface of the case within the hermetically-sealed housing;
an anode disposed within the hermetically-sealed housing; and
an immobilization system disposed between the anode and the hermetically-sealed housing, wherein the immobilization system is configured to minimize movement of the anode relative to the housing and is adapted to thermally insulate the anode during fabrication of the hermetically-sealed housing.

2. The electrochemical cell of claim 1, wherein the immobilization system comprises at least one material selected from the group consisting of polymer, glass, and ceramic.

3. The electrochemical cell of claim 1, wherein the immobilization system comprises a laminate.

4. The electrochemical cell of claim 1, wherein the immobilization system has a first surface adapted for contact with an interior surface of the hermetically-sealed housing, a second surface adapted for contact with an exterior surface of the anode and an intermediate portion having a thickness such that the immobilization system limits movement of the anode relative to the hermetically-sealed housing.

5. The electrochemical cell of claim 1, wherein the immobilization system comprises immobilization strips.

6. The electrochemical cell of claim 1, wherein the immobilization system comprises an immobilization ring.

7. The electrochemical cell of claim 1, wherein the immobilization system has a shape of a drum having a first side surface, a second side surface, and a band disposed therebetween.

8. The electrochemical cell of claim 1, wherein the immobilization system comprises one or more bumpers made of polymer foam or spray.

9. The electrochemical cell of claim 1, wherein the immobilization system comprises a thin corrugated film.

10. An electrochemical cell of an implantable medical device, the electrochemical cell comprising:
a hermetically-sealed housing formed by welding;
an anode disposed within the hermetically sealed housing; and
an immobilization system disposed between the anode and the housing, wherein the immobilization element is configured to substantially restrict movement of the anode relative to the housing, and wherein the immobilization system is formed of a non-electrically conductive material that thermally insulates the anode during the welding.

11. The electrochemical cell of claim 10, wherein the immobilization system has a first surface adapted for contact with an interior surface of the hermetically-sealed housing, a second surface adapted for contact with an exterior surface of the anode, and an intermediate portion having a thickness such that the immobilization system restricts movement of the anode relative to the hermetically-sealed housing.

12. The electrochemical cell of claim 11, wherein the electrochemical cell further comprises a separator and wherein the immobilization system comprises portions of the separator sealed together.

13. The electrochemical cell of claim 10, wherein the immobilization system comprises immobilization strips.

14. The electrochemical cell of claim 10, wherein the immobilization system comprises an immobilization ring.

15. The electrochemical cell of claim 10, wherein the immobilization system has a shape of a drum having a first side surface, a second side surface, and a band physically coupling the first side surface and the second side surface.

16. The electrochemical cell of claim 10, wherein the immobilization system comprises one or more bumpers made of polymer foam or spray.

17. The electrochemical cell of claim 10, wherein the immobilization system comprises a thin corrugated film.

18. An immobilization system of an electrochemical cell of an implantable medical device, wherein the electrochemical cell has a hermetically-sealed housing formed by welding, and an anode disposed within the housing, and wherein the immobilization system comprises:
a first surface adapted for physical contact with an interior surface of the hermitically-sealed housing;
a second surface adapted for physical contact with an exterior surface of the anode; and
an intermediate portion disposed between the first surface and the second surface, wherein the intermediate portion has a thickness such that the immobilization system is adapted to substantially restrict movement of the anode relative to the housing, and wherein the immobilization system comprises a material that thermally insulates the anode during the welding of the hermitically-sealed housing.

19. The immobilization system of claim 18, wherein the immobilization system comprises at least one material selected from the group consisting of polymer, glass, and ceramic.

20. The immobilization system of claim 18, wherein the first surface substantially contacts the interior surface of the hermetically-sealed housing when the second surface substantially contacts the exterior surface of the anode.
